(19) United States
(12) Patent Application Publication
(10) Pub. No.: US 2016/0106122 A1
(43) Pub. Date: Apr. 21, 2016

(54) ANIMAL FEED PRODUCT FOR MONOGASTRIC ANIMALS

(71) Applicant: DIREVO INDUSTRIAL BIOTECHNOLOGY GMBH, Köln (DE)

(72) Inventor: Klaudija Milos, Cologne (DE)

(73) Assignee: DIREVO Industrial Biotechnology GmbH, Cologne (DE)

(21) Appl. No.: 14/890,766

(22) PCT Filed: May 6, 2014
(86) PCT No.: PCT/EP2014/059209

§ 371 Date: Nov. 12, 2015

Related U.S. Application Data
(60) Provisional application No. 61/824,023, filed on May 16, 2013.

(30) Foreign Application Priority Data
May 16, 2013 (EP) 13168100.9

(51) Int. Cl. A23K 1/06

(52) U.S. Cl. CPC A23K 1/06; A23K 1/1826; A23K 1/007

(57) ABSTRACT

The present technology disclosed herein relates to animal feed compositions suitable for feeding monogastric animals comprising a high amount of distillers dried grains with solubles (DDGS) with improved nutrition quality, in particular DDGS with a reduced fiber content for a better availability and digestibility of the amino acids in the DDGS. Furthermore, animal feed compositions according to the present disclosure shows an excellent metabolizable energy (TME) value and energy associated with the carbohydrates, and are in particular useful for feeding poultry, in particular broilers directly after birth.

### FIELD OF THE INVENTION

The present disclosure relates to animal feed compositions suitable for feeding monogastric animals comprising a high amount of DDGS with improved nutrition quality, in particular DDGS with a reduced fiber content for a better availability and digestibility of the amino acids in the DDGS. Furthermore, animal feed compositions according to the present disclosure shows an excellent metabolizable energy (TME) value and energy associated with the carbohydrates, and are in particular useful for feeding poultries, in particular broilers directly after birth.

### BACKGROUND OF THE INVENTION

Recent record high feed ingredient prices around the world have caused animal nutritionists to search for lower cost alternative feed ingredients to minimize the cost of food animal production.

It is known to commercially use byproducts derived from the fermentation processes like the ethanol production process since they have a certain value as sources of protein and energy for animal feed.

For example, the fermentation by-product dried distillers grains with solubles (DDGS) is an excellent, lower cost alternative feed ingredient for dairy cattle, beef cattle, swine, poultry, and aquaculture that continues to be produced in large quantities by the dry-grind fuel ethanol industry. The high energy, protein, and phosphorus content of DDGS make it a very attractive partial replacement for some of the more expensive traditional energy (corn), protein (soybean meal), and phosphorus (mono- or dicalcium phosphate) ingredients used in animal feeds. Yet for many nutritionists, feed manufacturers, and animal producers around the world, DDGS is considered to be a new and unfamiliar feed ingredient.

Historically, over 85% of DDGS has been fed to dairy and beef cattle, and DDGS continues to be an excellent, economical feed ingredient for use in ruminant diets.

DDGS comprises proteins, fibers, fat and unconverted starch. For example usual used DDGS contains typically about 30% crude protein, 11% fat, 12% fiber, and 48% carbohydrates. While the protein content is high the amino acid composition is not well suited for monogastric animals if used as animal feed. In general processing of DDGS, especially drying time and temperature are effecting the availability and digestibility of the amino acids, especially lysine.

Furthermore, the by-products are mainly fibrous by-products comprising Crude Fibers (CF), which are structural carbohydrates consisting of cellulose, hemicellulose and indigestible materials like lignin. The structural carbohydrates are not digestible in animal's small intestine. Fibers are characterized and analyzed by different methods and can be divided into crude fibers (CF), neutral detergent fibers (NDF) and acid detergent fibers (ADF). The proportion of cellulose and lignin in the crude fibers fraction also determines the digestibility of crude fibers or its solubility in the intestine. High cellulose and lignin concentrations mean reduced digestibility and vice versa. Hemicelluloses are capable to bind water. The part of fibers that cannot be digested by monogastric animals like swine and poultry, are mainly the non-starch-polysaccharides (NSP) which increase viscosity, due to their capability to bind water, and are therefore a nutritional constraint, since they can cause moist, sticky droppings and wet litter. The antinutritional effect of NSP's is mainly related to the increase in digest a viscosity. The increased viscosity is slowing down the feed passage rate and hinders the intestinal uptake of nutrients and can lead to decreased feed uptake The viscosity increase a) hinders the intestinal absorption of nutrients and can result in negative effect on the consistency on faces and even symptoms of diarrhea, b) slowing down the feed passage rate and possibly to decreased feed intake. Another effect of NSP's is the so-called “Nutrient Encapsulation”. The NSP's in plant cell wall encapsulated starch, protein, oil and other nutrients within the plant cell which is an impermeable barrier preventing full utilization of the nutrients within the cell.

A considerable amount of research has been conducted on the effects of feeding DDGS to poultry. Corn DDGS is an excellent feed ingredient for use in layer, broiler, duck and turkey diets and contains approximately 85% of the energy value in corn, has moderate levels of protein and essential amino acids, and is high in available phosphorus. DDGS is an acceptable ingredient for use in poultry diets and can be safely added at levels of 5% in starter diets for broilers and turkeys, and 12-15% in grower-finisher diets for broilers, turkeys, and laying hens. Higher inclusion rates of standard DDGS especially in the starter period is not possible and leads to slower growth a reduced body weight.

In order to further minimize the cost associated with dietary energy and amino acids in feeding animals, there is a need to develop and technologies that increase digestibility of energy and other nutrients in feed ingredients like DDGS and enable high inclusion rates of these products in all growth periods of monogastric animals like poultry or pigs.

Therefore, a need exists in the field of keeping monogastric animals for improved feed products comprising DDGS, in particular for feeding monogastric animals like pigs and broilers.

### SUMMARY OF THE DISCLOSURE

The present disclosure relates to animal feed compositions comprising DDGS with improved nutrition quality, in particular DDGS with a reduced fiber content for a better availability and digestibility of the amino acids in the DDGS. Furthermore, animal feed composition according to the present disclosure shows an excellent metabolizable energy (TME) value and is in particular useful for feeding poultries, in particular broilers directly after birth. The energy associated with the carbohydrates in grain co-products like DDGS can be to utilized for enabling inclusion levels of at least 10% during all growth periods of the animals.

In a first aspect, the present disclosure pertains to animal feed compositions suitable for feeding monogastric animals, in particular for poultries like broilers, comprising 5.0 to 15.0 weight percent of a distillers dried grains with solubles (DDGS), wherein said DDGS has:

(a) a crude fiber content less than 5.0 weight percent,
(b) a NDF content of less than 30.0 weight percent,
(c) a ADF content of less than 10 weight percent, and

In a second aspect, the present disclosure relates to monogastric animal feeds comprising at least 10 percent DDGS on a dry weight basis, wherein said DDGS is generated as a by-product in a fermentation process comprising the step of subjecting the fermented mash after the fermentation to an enzyme composition comprising an enzyme or a mixture of enzymes capable of degrading one or more fermented mash components.

In a third aspect, the present disclosure pertains to methods of feeding broilers in the feeding period of 0 to 14 days after birth comprising incorporating into a feed ration a DDGS meal comprising at least 10 percent DDGS on a dry weight basis, wherein said DDGS is generated as a by-product in a fermentation process comprising the step of subjecting the fermented mash after the fermentation to an enzyme composition comprising an enzyme or a mixture of enzymes capable of degrading one or more fermented mash components.

### BRIEF DESCRIPTION OF THE DRAWING

FIG. 1 is a diagram showing the weight gain per animal as a result of an animal trial with broiler chicken using an animal feed composition according to the present disclosure.

FIG. 2 is a diagram showing the feed to gain value as a result of an animal trial with broiler chicken using an animal feed composition according to the present disclosure.

### DESCRIPTION OF THE INVENTION

The object of the present invention is to provide improved animal feed compositions comprising DDGS for feeding monogastric animals due to a low fiber content and an increased metabolizable energy (TME) value of the DDGS.

In particular, the present disclosure relates to the use of DDGS derived from biofuel production processes for monogastric animal feed. Co-products as distillers grains are rich in structural carbohydrates like celluloses and hemicelluloses. There is a great need to increase the ability of monogastric animals like pigs and broilers to utilize the energy associated with the carbohydrates in grain co-products.

The present disclosure pertains to a animal feed composition/product comprising highly digestible DDGS in an amount between 5.0 to 15.0, preferably 10.0 weight percent. The high amount of comprised DDGS in the animal feed composition is novel and shows an immense benefit.

As mentioned above, DDGS are often used as a feed supplement for livestock and poultry fed high grain content finishing diets. Usually, DDGS have approximately 30% by weight crude protein (“CP”) and 20% crude fiber (“CF”).

In one embodiment, the DDGS disclosed herein may be used to supplement animal diets at a desired percentage of the total diet, on a dry matter basis. In one embodiment, the distillers meal may be used as a CP supplement in livestock and poultry feed diets. In addition, the animal feed compositions described herein may also be used as an animal feed or feed supplement that provides desired amounts of carbohydrates and amino acids. The DDGS can be used at a high percentage of the total feed that maximizes the nutritional components of the feed for monogastric animals. The relative amount of the DDGS incorporated into a monograstic animal diet may depend on, for example, the species, sex, or agricultural use of the animal being fed. Additionally, the relative amount of distillers meal incorporated into a particular diet may depend on the nutritional goals of the diet.

One embodiment of the present disclosure pertains to animal feed compositions suitable for feeding monogastric animals, in particular for poultries like broilers, comprising 5.0 to 15.0 weight percent of a distillers dried grains with solubles (DDGS), wherein said DDGS has:

(a) a crude fiber content less than 5.0 weight percent,
(b) a NDF content of less than 30.0 weight percent,
(c) a ADF content of less than 10 weight percent, and

Surprisingly it was found by the inventor that the animal feed compositions according to the present disclosure are suitable for feeding poultries in the feeding period of 0 to 14 days.

In a further embodiment, the animal feed composition according to the present disclosure comprises DDGS with:

(a) a crude fiber content of from 3.0 to 5.0 weight percent,
(b) a NDF content of less than 30.0 weight percent, and
(c) a ADF content of less than 10 weight percent.

Furthermore, the inventor found that animals when fed with the animal feed compositions according to the present disclosure gained more weight as compared with control feed, both comprising DDGS. At the same time the feed to gain rate can be reduced. Therefore, the animal feed compositions according to the present disclosure have a high value as an animal feed and can be used with a high DDGS content, in particular with at least 10% DDGS already in early stage feeding of monogastic animals like broilers with improved growth and feed efficiency.

As mentioned before, the animal feed composition according to the present disclosure comprises DDGS with low fiber content and having a higher TME value than feeds comprising DDGS, which contain higher content of fibers. Stated another way, the animal will absorb more energy from the present treated feed than an untreated feed.

In an advantageous embodiment, the TME value of said DDGS comprised in an animal feed composition according to the present disclosure is at least 5% higher compared to DDGS produced in a fermentation process without subjecting the fermented mash after the fermentation to an enzyme composition.

In an advantageous embodiment, the TME value of said DDGS comprised in an animal feed composition according to the present disclosure is between 6% to 8% higher compared to DDGS produced in a fermentation process without subjecting the fermented mash after the fermentation to an enzyme composition.

In one aspect the DDGS is derived from starch-containing material in a processes for producing fermentation products comprising the steps of: i) subjecting the fermented mash after the fermentation to an enzyme composition comprising an enzyme or a mixture of enzymes capable of degrading one or more fermented mash components, ii) separating the desired fermentation product.

The DDGS is the dried residue remaining after the starch fraction of corn is fermented with selected yeasts and enzymes to produce ethanol and carbon dioxide. After complete fermentation, the alcohol is removed by distillation and the remaining fermentation residues are dried.

Stillage is the product, which remains after the mash, has been converted to sugar, fermented and distilled into ethanol. Stillage can be separated into two fractions, such as, by centrifugation or screening: (1) wet cake (solid phase) and (2) the thin stillage (supernatant). The solid fraction or distillers' wet grain (DWG) can be pressed to remove excess moisture and then dried to produce distillers' dried grains (DDG). After ethanol has been removed from the liquid fraction, the remaining liquid can be evaporated to concentrate the soluble material into condensed distillers' solubles (DS) or dried and ground to create distillers' dried solubles (DDS). DDS is often mixed with DDG to form distillers' dried grain with solubles (DDGS). DDG, DDGS, and DWG are collectively referred to as distillers' grain(s).

In an advantageous embodiment of the present disclosure enzymes were added during and/or preferably after the fermentation in the production process to the fermented mash and before the separation step like distillation, where the desired fermentation main product is separated from the rest of the fermented mash. The enzymes according to the present disclosure were capable of degrading components in the fermented mash (beer or beer mash) which improves the quality of the DDGS.

In an advantageous embodiment, the enzyme composition comprises a beta 1,3 glucanase and a xylanase as main activities.

The DDGS may be derived from the fermentative production process of any suitable fermentation product. The feedstock for producing the fermentation product may be any starch- and/or sugar containing material, preferably starch- and/or sugar containing plant material, including: sugar cane, tubers, roots, whole grain; and any combination thereof.

The starch-containing material may be obtained from cereals. Suitable starch-containing material includes corn (maize), wheat, barley, cassava, sorghum, rye, triticale, potato, or any combination thereof.

Corn is the preferred feedstock, especially when the fermentation product is ethanol. The starch-containing material may also consist of or comprise, e.g., a side stream from starch processing, e.g., C6 carbohydrate containing process streams that may not be suited for production of syrups. Beer components include fiber, hull, germ, oil and protein components from the starch-containing feedstock as well as non-fermented starch, yeasts, yeast cell walls and residuals. Production of a fermentation product is typically divided into the following main process stages: a) Reducing the particle size of starch-containing material, e.g., by dry or wet milling; b) Cooking the starch-containing material in aqueous slurry to gelatinize the starch, c) Liquefying the gelatinized starch-containing material in order to break down the starch (by hydrolysis) into maltodextrins (dextrins); d) Saccharifying the maltodextrins (dextrins) to produce low molecular sugars (e.g., DP1-2) that can be metabolized by a fermenting organism; e) Fermenting the saccharified material using a suitable fermenting organism directly or indirectly converting low molecular sugars into the desired fermentation product; f) Recovering the fermentation product, e.g., by distillation in order to separate the fermentation product from the fermentation mash.

As also explained above beer (or fermented mash) is the fermentation product consisting of ethanol, other liquids and solids of a desired fermentation product. According to the invention the fermentation product may be any fermentation product, including alcohols (e.g., ethanol, methanol, butanol, 1,3-propanediol); organic acids (e.g., citric acid, acetic acid, itaconic acid, lactic acid, gluconic acid, gluconate, succinic acid, 2,5-diketo-D-gluconic acid); ketones (e.g., acetone); amino acids (e.g., glutamic acid); gases (e.g., H2 and CO2), and more complex compounds, including, for example, antibiotics (e.g., penicillin and tetracycline); enzymes; vitamins (e.g., riboflavin, B12, beta-carotene); and hormones. Fermentation is also commonly used in the production of consumable alcohol (e.g., spirits, beer and wine), dairy (e.g., in the production of yogurt and cheese), leather, and tobacco industries. In a preferred embodiment the fermentation product is a liquid, preferably an alcohol, especially ethanol. The beer contemplated according to the invention may be the product resulting from a fermentation product production process including above-mentioned steps a) to f). However, the beer may also be the product resulting from other fermentation product production processes based on starch- and/or lignocellulose containing starting material.

The fermenting organism may be a fungal organism, such as yeast, or bacteria. Suitable bacteria may e.g. be Zymomonas species, such as Zymomonas mobilis and E. coli. Examples of filamentous fungi include strains of Penicillium species. Preferred organisms for ethanol production are yeasts, such as e.g. Pichia or Saccharomyces. Preferred yeasts according to the disclosure are Saccharomyces species, in particular Saccharomyces cerevisiae or baker's yeast.

In a further embodiment, the solids from the fermentation step can be fractionated. After fermentation large pieces of fibers could be removed prior or after distillation. Removal can be effected with a surface skimmer before to distillation of beer. The material can be separated from the ethanol/water mix by, e.g. centrifugation. Alternatively, fibers and germs can be removed by screening the whole stillage after distillation or the grinded grains before fermentation. After germs and large pieces of fibers are removed the remaining beer or whole stillage are treated with enzymes or enzyme combinations to further improve the nutritional quality of the DDGS to be used.

The processes for producing fermentation products includes the production of a large number of fermentation products comprising but not limited to alcohols (in particular ethanol); acids, such as citric acid, itaconic acid, lactic acid, gluconic acid, lysine; ketones; amino acids, such as glutamic acid, but also more complex compounds such as antibiotics, such as penicillin, tetracyclin; enzymes; vitamins, such as riboflavin, B12, beta-carotene; hormones, such as insulin. Preferred is drinkable ethanol as well as industrial and fuel ethanol.

Processes for producing fermentation products, such as ethanol, from a starch or lignocellulose containing material are well known in the art. The preparation of the starch-containing material such as corn for utilization in such fermentation processes typically begins with grinding the corn in a dry-grind or wet-milling process. Wet-milling processes involve fractionating the corn into different components where only the starch fraction enters into the fermentation process. Dry-grind processes involve grinding the corn kernels into meal and mixing the meal with water and enzymes. Generally two different kinds of dry-grind processes are used. The most commonly used process, often referred to as a “conventional process,” includes grinding the starch-containing material and then liquefying gelatinized starch at a high temperature using typically a bacterial alpha-amylase, followed by simultaneous saccharification and fermentation (SSF) carried out in the presence of a glucoamylase and a fermentation organism. Another well-known process, often referred to as a “raw starch hydrolysis” process (RSH process), includes grinding the starch-containing material and then simultaneously saccharifying and fermenting granular starch below the initial gelatinization temperature typically in the presence of an acid fungal alpha-amylase and a glucoamylase.

In a process for producing ethanol from corn, following SSF or the RSH process the ethanol is distilled from the whole mash after fermentation. The resulting ethanol-free slurry, usually referred to as whole stillage, is separated into solid and liquid fractions (i.e., wet cake and thin stillage containing about 35 and 7% solids, respectively). The thin stillage is often condensed by evaporation into a thick stillage or syrup and recombined with the wet cake and further dried into distillers' dried grains with solubles distillers' dried grain with solubles (DDGS) for use in animal feed.

Enzymes used for degrading beer components include carbohydrases such as alpha-amylase, glucoamylase, cellulase and/or hemicellulases, such as mannanases, xylanases and beta-glucanases, pectinases and proteases, or a mixture thereof. In an advantageous embodiment, the enzyme composition comprises a beta 1,3 glucanase and a xylanase as main activities.

In advantageous embodiment, the enzyme compositions comprise a beta-1,3-glucanase, in particular for the degradation of the cell walls from the fermenting microorganisms. To avoid the degradation of the fermentative microorganisms the enzyme composition is added after the fermentation step. As used herein “after the fermentation” or “after the fermentation step” means that a large part or all of the fermentable sugars like glucose are converted to the desired fermentation products such as ethanol.

In an embodiment, the enzyme composition comprises a beta-1,3-glucanase and a 1,6-beta-glucanase. In another embodiment, the enzyme composition comprises a xylanase. In an advantageous embodiment, the enzyme composition comprises a beta-1,3-glucanase and a xylanase. In another embodiment, the enzyme composition comprises a beta-1,3-glucanase, a 1,6-beta-glucanase and a xylanase.

In further embodiments, the enzyme composition comprises in addition a pectinase and/or a protease. In an example the enzyme composition comprises a beta-1,3-glucanase, a xylanase and a protease. In another example the enzyme composition comprises a beta-1,3-glucanase, a xylanase and a pectinase.

In a further embodiment, enzyme composition comprises a mannanase. In an advantageous embodiment the enzyme composition comprises a mannanase and a beta-1,3-glucanase.

Beta-1,3-glucanases as used herein are enzymes capable of degrading of glucan. Glucan and chitin are far more resistant to microbial degradation than cellulose, which is the major constituent of the cell wall of many yeasts and fungi-like organisms. Glucan is predominantly beta-1,3-linked with some branching via 1,6-linkage (Manners et al., Biotechnol. Bioeng, 38, p. 977, 1973), and is known to be degradable by certain beta-1,3-glucanase systems. beta-1,3-glucanase includes the group of endo-beta-1,3-glucanases also called laminarinases (E.C. 3.2.1.39 and E.C. 3.2.1.6, Enzyme Nomenclature, Academic Press, Inc. 1992).

A number of beta-1,3-glucanase genes and uses thereof have been disclosed in the prior art. An example is DD 226012 (Akad. Wissenshaft, DDR) which concerns a method for production of a Bacillus beta-1,3-glucanase. Further, JP 61040792 A (DOI K) describes a cell wall-cytolase beta-1,3-glucanase recombinant plasmid for removing the cell walls of yeast. The gene is derived from Arthrobacter and is transformed in Escherichia group bacteria. EP 440.304 concerns plants provided with improved resistance against pathogenic fungi transformed with at least one gene encoding an intracellular chitinase, or in intra- or extracellular beta-1,3-glucanase. The matching recombinant polynucleotides is also disclosed. WO 87/01388 (The Trustees of Columbia University) describes a method for preparing cell lytic enzymes, such as beta-1,3-glucanases, which can be produced by Oerksovia. WO 92/03557 (Majesty (Her) in Right of Canada) discloses a recombinant DNA expression vector comprising a 2.7 kb DNA sequence, derived from Oerskovia xanthineolytica, encoding a beta-1,3-glucanase. From WO 92/16632 a recombinant DNA sequence coding for a novel protein with beta-1,3-glucanase activity, is known.

Examples for commercial available beta-1,3-glucanase are Rohalase BX from AB Enzymes and Rapidase Glucalees from DSM.

Hemicellulases as used herein are enzymes capable to break down hemicellulose. Any hemicellulase suitable for use in hydrolyzing hemicellulose, preferably into xylose, may be used. Preferred hemicellulases include acetylxylan esterases, endo-arabinases, exo-arabinases, arabinofuranosidases, feruloyl esterase, endo-galactanases, exo-galactanases, glucuronidases, mannases, xylanases, and mixtures of two or more thereof. Preferably, the hemicellulase for use in the present invention is an exo-acting hemicellulase, and more preferably, the hemicellulase is an exo-acting hemicellulase which has the ability to hydrolyze hemicellulose under acidic conditions of below pH 7, preferably pH 3-7.

In one aspect, the hemicellulase(s) comprises a commercial hemicellulolytic enzyme preparation. Examples of commercial hemicellulolytic enzyme preparations suitable for use in the present invention include, for example, SHEARZYME™ (Novozymes A/S), CELLIC™ HTec (Novozymes A/S), CELLIC™ HTec2 (Novozymes A/S), VISCOZYME® (Novozymes A/S), ULTRAFLO® (Novozymes A/S), PULPZYME® HC (Novozymes A/S), MULTIFECT® Xylanase (Genencor), ACCELLERASE® XY (Genencor), ACCELLERASE® XC (Genencor), ECOPULP® TX-200A (AB Enzymes), HSP 6000 Xylanase (DSM), DEPOL™ 333P (Biocatalysts Limit, Wales, UK), DEPOL™ 740L. (Biocatalysts Limit, Wales, UK), and DEPOL™ 762P (Biocatalysts Limit, Wales, UK).

Preferably, the hemicellulase for use in the present disclosure is an endo-acting hemicellulase, which has the ability to hydrolyze hemicellulose under acidic conditions of below pH 7. An example of hemicellulase suitable for use in the present invention includes VISCOZYME L™ (available from Novozymes A/S, Denmark), Rohament GMP™ (available from AB Enzymes).

In an embodiment the hemicellulase is a xylanase. In an embodiment the xylanase may preferably be of microbial origin, such as of fungal origin (e.g., Aspergillus, Fusarium, Humicola, Meripilus, Trichoderma) or from a bacterium (e.g., Bacillus). In a preferred embodiment the xylanase is derived from a filamentous fungus, preferably derived from a strain of Aspergillus, such as Aspergillus aculeatus; or a strain of Humicola, preferably Humicola lanuginosa. Examples of xylanases useful in the methods of the present invention include, but are not limited to, Aspergillus aculeatus xylanase (GeneSeqP:AAR63790; WO 94/21785), Aspergillus fumigatus xylanases (WO 2006/078256), and Thielavia terrestris NRRL 8126 xylanases (WO 2009/079210). The xylanase may preferably be an endo-1,4-beta-xylanase, more preferably an endo-1,4-beta-xylanase of GH 10 or GH 1 1. Examples of commercial xylanases include SHEARZYME™, BIOFEED WHEAT™, HTec and HTec2 from Novozymes A/S, Denmark.

Examples of beta-xylosidases useful in the methods of the present invention include, but are not limited to, Trichoderma reesei beta-xylosidase (UniProtKB/TrEMBL accession number Q92458), Talaromyces emersonii (SwissProt accession number Q8X212), and Neurospora crassa (Swiss Prot accession number Q7SOW4).

According to the disclosure beer may in step i) be subjected to an effective amount of any xylanase (EC 3.2.1.8), such as any of below mentioned xylanases. Xylanase activity may be derived from any suitable organism, including fungal and bacterial organisms. Fungal xylanases may be derived from strains of genera including Aspergillus, Disporotrichum, Penicillium, Neurospora, Fusarium and Trichoderma.

Examples of suitable bacterial xylanases include include xylanases derived from a strain of Bacillus, such as Bacillus subtilis, such as the one disclosed in U.S. Pat. No. 5,306,633 or

Contemplated commercially available xylanases include SHEARZYM E™, BIOFEED WHEAT™, (from Novozymes AJS), Econase CE™ (from AB Enzymes), Depol 676™ (from Biocatalysts Ltd.) and SPEZYME™ CP (from Genencor Int.).).

Xylanase may be added in an amount effective in the range from 0.16×10⁶-460×10⁶ Units per ton beer mash.

In another aspect, the present disclosure relates to animal feed composition according to the present disclosure, wherein the DDGS is produced by a process comprising the steps of:
i) Converting starch containing material to fermentable sugars
ii) Fermentation of the fermentable sugars with a microorganism to fermented mash
iii) Subjecting the fermented mash after the fermentation process to an enzyme composition comprising an enzyme or a mixture of enzymes
iv) Separation of the ethanol in the fermented mash by distillation
v) separating the solids that remain after said fermentation into an insoluble solids and soluble solids fraction,
vi) concentrating said soluble solids fraction into a high solids-containing syrup, and recovering and combining said insoluble solids fraction and the high solids-containing syrup produced from said soluble solids fraction and together drying said insoluble and soluble solids fraction to produce the DDGS

Converting starch-containing material to fermentable sugars can be done by (a) liquefying a starch-containing material and (b) saccharifying the liquefied material obtained in step (a).

The liquefaction is preferably carried out in the presence of an alpha-amylase, preferably a bacterial alpha-amylase or acid fungal alpha-amylase. In an embodiment, a pullulanase, isoamylase, and and/or phytase is added during liquefaction.

Preferred organisms for ethanol production are yeasts, such as e.g. Pichia or Saccharomyces. Preferred yeast according to the disclosure is Saccharomyces species, in particular Saccharomyces cerevisiae or baker's yeast. The yeast cells may be added in amounts of 105 to 1012, preferably from 107 to 101, especially 5x107viable yeast count per ml of fermentation broth. During the ethanol producing phase the yeast cell count should preferably be in the range from 10⁷ to 10¹⁰, especially around 2×10⁸. Further guidance in respect of using yeast for fermentation can be found in, e.g., “The alcohol Textbook” (Editors K. Jacques, T. P. Lyons and D. R. Kelsall, Nottingham University Press, United Kingdom 1999), which is hereby incorporated by reference

The microorganism used for the fermentation is added to the mash and the fermentation is ongoing until the desired amount of fermentation product is produced; in a preferred embodiment wherein the fermentation product is ethanol to be recovered this may, e.g. be for 24-96 hours, such as 35-60 hours. The temperature and pH during fermentation is at a temperature and pH suitable for the microorganism in question and with regard to the intended use of the fermentation product, such as, e.g., in an embodiment wherein the fermenting organism is yeast and the product is ethanol for recovery the preferred temperature is in the range about 26-34 C, e.g. about 32 C, and at a pH e.g. in the range about pH 3-6, e.g. about pH 4-5.

In another embodiment wherein the fermenting organism is yeast, and the fermented mash is to be used as a beer, the temperature of the mash the preferred temperature is around 12-16 C, such around 14 C.

As mentioned above, the fermenting organism is preferably yeast, e.g., a strain of Saccharomyces cerevisiae or Saccharomyces diastaticus. In an advantageous embodiment a yeast strain of Saccharomyces diastaticus is used (SIHA Amyloferm®, E. Begerow GmbH&Co, Langenlonsheim, Germany) since their exo-amylase activity can split liquid starch and also dextrin, maltose and melibiose.

In the liquefaction step the gelatinized starch (downstream mash) is broken down (hydrolyzed) into maltodextrins (dextrins). To achieve starch hydrolysis a suitable enzyme, preferably an alpha-amylase, is added. Liquefaction may be carried out as a three-step hot slurry process. The slurry is heated to between 60-95° C., preferably 80-85° C., and an alpha-amylase may be added to initiate liquefaction (thinning). Then the slurry may be jet-cooked at a temperature between 95-140° C., preferably 105-125° C., for about 1-15 minutes, preferably for about 3-10 minutes, especially around about 5 minutes. The slurry is cooled to 60-95° C. and more alpha-amylase may be added to complete the hydrolysis (secondary liquefaction). The liquefaction process is usually carried out at a pH of 4.0 to 6.5, in particular at a pH of 4.5 to 6.

The saccharification step and the fermentation step may be performed as separate process steps or as a simultaneous saccharification and fermentation (SSF) step. The saccharification is carried out in the presence of a saccharifying enzyme, e.g. a glucoamylase, a beta-amylase or maltogenic amylase. Optionally a phytase and/or a protease is added.

Saccharification may be carried out using conditions well known in the art with a saccharifying enzyme, e.g., beta-amylase, glucoamylase or maltogenic amylase, and optionally a debranching enzyme, such as an isoamylase or a pullulanase. For instance, a full saccharification process may last up to from about 24 to about 72 hours, however, it is common to do a pre-saccharification for typically 40-90 minutes at a temperature between 30-65° C., typically about 60° C., followed by complete saccharification during fermentation in a simultaneous saccharification and fermentation process (SSF process). Saccharification is typically carried out at a temperature from 20-75° C., preferably from 40-70° C., typically around 60° C., and at a pH between 4 and 5, normally at about pH 4.5.

The most widely used process to produce a fermentation product, especially ethanol, is the simultaneous saccharification and fermentation (SSF) process, in which there is no holding stage for the saccharification, meaning that a fermenting organism, such as a yeast, and enzyme(s), including the hemicellulase(s) and/or specific endoglucanase(s), may be added together. SSF is typically carried out at a temperature from 25° C. to 40° C., such as from 28° C. to 35° C., from 30° C. to 34° C., preferably around about 32° C. In an embodiment, fermentation is ongoing for 6 to 120 hours, in particular 24 to 96 hours.

After the fermentation, the fermented mash is subjected to an enzyme composition according to the present disclosure. In an embodiment, the enzyme composition comprises a beta-1,3-glucanase. In another embodiment the enzyme composition comprises a beta-1,3-glucanase and a 1,6-beta-glucanase. In another embodiment, the enzyme composition comprises a xylanase. In an advantageous embodiment, the enzyme composition comprises a beta-1,3-glucanase and a xylanase. In another embodiment, the enzyme composition comprises a beta-1,3-glucanase, a 1,6-beta-glucanase and a xylanase. In further embodiments, the enzyme composition comprises in addition a pectinase and/or a protease. In an example the enzyme composition comprises a beta-1,3-glucanase, a xylanase and a protease. In another example the enzyme composition comprises a beta-1,3-glucanase, a xylanase and a pectinase. In a further embodiment, enzyme composition comprises a mannanase. In an advantageous embodiment the enzyme composition comprises a mannanase and a beta-1,3-glucanase.

In a particular embodiment, the process of the invention further comprises, prior to liquefying the starch-containing material the steps of:
reducing the particle size of the starch-containing material, preferably by milling; and
forming a slurry comprising the starch-containing material and water.

The aqueous slurry may contain from 10-55 w/w % dry solids (DS), preferably 25-45 w/w % dry solids (DS), more preferably 30-40 w/w % dry solids (DS) of the starch-containing material. The slurry is heated to above the gelatinization temperature and an alpha-amylase, preferably a bacterial and/or acid fungal alpha-amylase, may be added to initiate liquefaction (thinning). The slurry may be jet-cooked to further gelatinize the slurry before being subjected to an alpha-amylase in step (a).

In a preferred embodiment, the starch containing material is milled cereals, preferably barley or corn, and the methods comprise a step of milling the cereals before step (a). In other words, the disclosure also encompasses methods, wherein the starch containing material is obtainable by a process comprising milling of cereals, preferably dry milling, e.g. by hammer or roller mils. Grinding is also understood as milling, as is any process suitable for opening the individual grains and exposing the endosperm for further processing. Two processes of milling are normally used in alcohol production: wet and dry milling. The term “dry milling” denotes milling of the whole grain. In dry milling the whole kernel is milled and used in the remaining part of the process Mash formation. The mash may be provided by forming a slurry comprising the milled starch containing material and brewing water. The brewing water may be heated to a suitable temperature prior to being combined with the milled starch containing material in order to achieve a mash temperature of 45 to 70° C., preferably of 53 to 66° C., more preferably of 55 to 60° C. The mash is typically formed in a tank known as the slurry tank.

Subsequent to fermentation the fermentation product may be separated from the fermentation medium. The slurry may be distilled to extract the desired fermentation product or the desired fermentation product from the fermentation medium by micro or membrane filtration techniques. Alternatively the fermentation product may be recovered by stripping. Methods for recovering fermentation products are well known in the art. Typically, the fermentation product, e.g., ethanol, with a purity of up to, e.g., about 96 vol. % ethanol is obtained.

Following the completion of the fermentation process, the material remaining is considered the whole stillage. As used herein, the term “whole stillage” includes the material that remains at the end of the fermentation process both before and after recovery of the fermentation product, e.g., ethanol. The fermentation product can optionally be recovered by any method known in the art. In one embodiment, the whole stillage is separated or partitioned into a solid and liquid phase by one or more methods for separating the thin stillage from the wet cake. Such methods include, for example, centrifugation and decanting. The fermentation product can be optionally recovered before or after the whole stillage is separated into a solid and liquid phase.

Thus, in one embodiment, the methods of the disclosure further comprise distillation to obtain the fermentation product, e.g., ethanol. The fermentation and the distillation may be carried out simultaneously and/or separately/sequentially; optionally followed by one or more process steps for further refinement of the fermentation product.

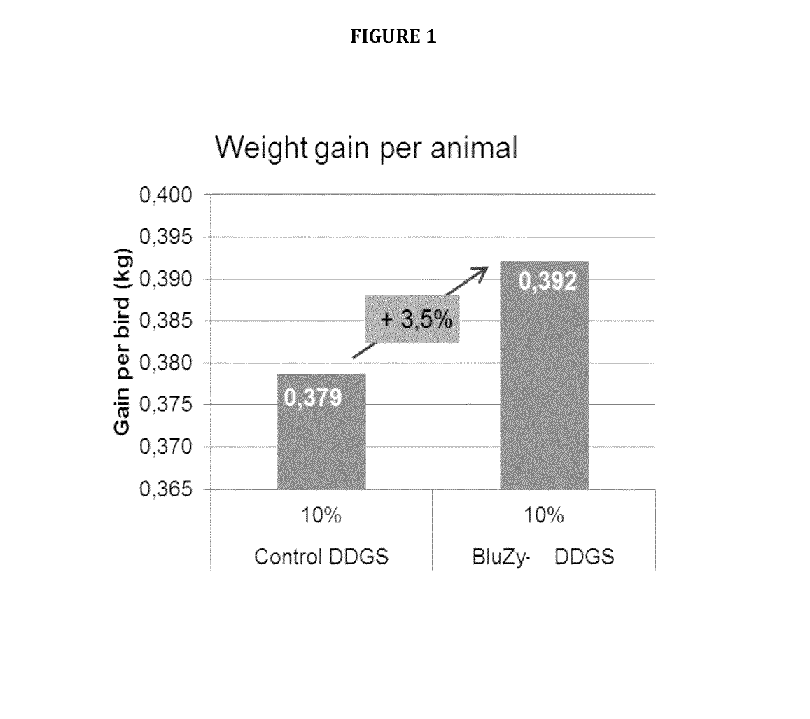

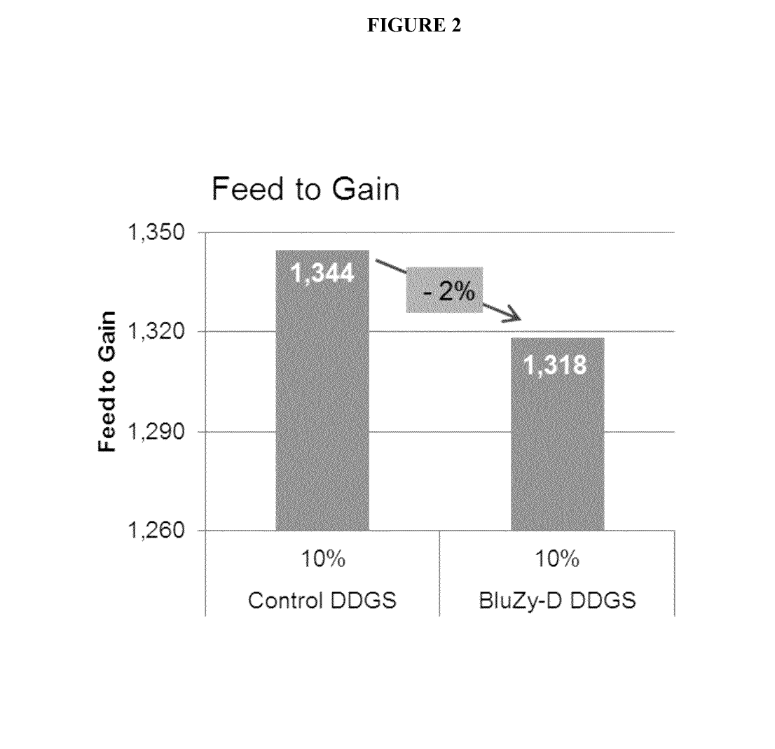

In an embodiment, the aqueous by-product (whole stillage) from the distillation process is separated into two fractions, e.g., by centrifugation: wet grain (solid phase), and thin stillage (supernatant). In another embodiment, the methods of the disclosure further comprise separation of the whole stillage produced by distillation into wet grain and thin stillage; and recycling thin stillage to the starch containing material prior to liquefaction. In one embodiment, the thin stillage is recycled to the milled whole grain slurry. The wet grain fraction may be dried, typically in a drum dryer. The dried product is referred to as distillers dried grains, and can be used as mentioned above as high quality animal feed. The thin stillage fraction may be evaporated providing two fractions (see FIG. 1 and FIG. 2), (i) a condensate fraction of 4-6% DS (mainly of starch, proteins, and cell wall components), and (ii) a syrup fraction, mainly consisting of limit dextrins and non-fermentable sugars, which may be introduced into a dryer together with the wet grains (from the whole stillage separation step) to provide a product referred to as distillers dried grain with solubles, which also can be used as animal feed. Thin stillage is the term used for the supernatant of the centrifugation of the whole stillage. Typically, the thin stillage contains 4-6% DS (mainly starch and proteins) and has a temperature of about 60-90° C. In another embodiment, the thin stillage is not recycled, but the condensate stream of evaporated thin stillage is recycled to the slurry containing the milled whole grain to be jet cooked.

Further details on how to carry out liquefaction, saccharification, fermentation, distillation, and recovering of ethanol are well known to the skilled person.

The fermentation product(s) can be optionally recovered from the fermentation medium using any method known in the art including, but not limited to, chromatography, electrophoretic procedures, differential solubility, distillation, or extraction. For example, alcohol is separated from the fermented cellulosic material and purified by conventional methods of distillation as mentioned above. Ethanol with a purity of up to about 96 vol. % can be obtained, which can be used as, for example, fuel ethanol, drinking ethanol, i.e., potable neutral spirits, or industrial ethanol.

Examples describing the production of high digestible DDGS are shown in WO2012/084225.

In further embodiments, the present disclosure pertains to a monogastric animal feed comprising at least 10 percent DDGS on a dry weight basis, wherein said DDGS is generated as a by-product in a fermentation process comprising the step of subjecting the fermented mash after the fermentation to an enzyme composition comprising an enzyme or a mixture of enzymes capable of degrading one or more fermented mash components.

Monogastrics cannot digest the fiber molecule cellulose as efficiently as ruminants, though the ability to digest cellulose varies amongst species Preferred examples of monogastric animals are poultry like broilers and swins.

In an advantageous embodiment, the present disclosure pertains to a method of feeding broilers in the feeding period of 0 to 14 days after birth comprising incorporating into a feed ration a DDGS meal comprising at least 10 percent DDGS on a dry weight basis, wherein said DDGS is generated as a by-product in a fermentation process comprising the step of subjecting the fermented mash after the fermentation to an enzyme composition comprising an enzyme or a mixture of enzymes capable of degrading one or more fermented mash components.

The inventions described and claimed herein are not to be limited in scope by the specific embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims. In the case of conflict, the present disclosure including definitions will control. Various references are cited herein, the disclosures of which are incorporated by reference in their entireties. The present invention is further described by the following examples, which should not be construed as limiting the scope of the invention.

### EXAMPLES

### Example 1

Feeding enzyme treated DDGS at 10% in starter period to broiler chicken.

This example describes a feeding trial with broilers comparing the performance of a commodity DDGS with the DDGS produced as a by-product in a fermentation process comprising the step of subjecting the fermented mash after the fermentation to an enzyme composition comprising an enzyme or a mixture of enzymes capable of degrading one or more fermented mash components (“treated DDGS”). The enzyme composition comprised the commercial product BluZy having 1?-1,3, glucanase and xylanase as main enzyme activities.

The following table 1 shows the trial protocol:

TABLE 1

| | |
|---|---|
| Study Animals: | Broiler Chicken |
| Breed/Strain: | Cobb 500 fast feathering male |
| Description: | Day-of-hatch chicks |
| Sex: | Male |
| Origin: | Cobb Hatchery in Cleveland, GA |
| Breeder Flock Age: | 38 weeks of age |
| Initial Age: | 1 day |
| Initial Weight: | 38 to 50 grams |

### Trial Set Up:

8 pens per treatment
19 birds per pen
Mash diets, formulated on a digestible amino acid basis
Standard lighting and temperature protocols
Starter Period: 0-14 days of age

### Performance Parameters

Weight gain in kg/broiler
Feed to gain
The feed to gain ratio is value that expresses how well an animal converts feed into body weight. The lower the value the higher the efficiency of converting feed into muscle mass.

### Dietary Treatments:

Non enzyme treated DDGS(=control DDGS) at 10, 15, and 20% in starter, grower Control DDGS and finisher [with a low energy diet (7.5% less than control)]

Enzyme 1 treated DDGS at 10, 15, and 20% in starter, grower and finisher, diet BluZy-treated formulated with the energy and amino acid specifications of the non enzyme DDGS treated DDGS [with a low energy diet (7.5% less than control)]

Composition of the experimental diets

Starter¹
Treatments

| | Control | BluZy D |
|---|---|---|
| | DDGS | DDGS |
| | % | % |
| Ingredient | | |
| Corn | 48.34 | 48.34 |
| Soybean meal, 48% CP | 35.44 | 35.44 |
| DDGS² | 10.00 | 10.00 |
| Dicalcium Phosphate | 0.98 | 0.98 |
| Soybean oil | 0.00 | 0.00 |
| Limestone | 1.47 | 1.47 |
| Salt | 0.23 | 0.23 |
| Sodium Carbonate | 0.23 | 0.23 |
| DL- Methionine 99% | 0.34 | 0.34 |
| Vitamin mix³ | 0.23 | 0.23 |
| L-Lysine, HCl 78.8% | 0.20 | 0.20 |
| L-Threonine 98% | 0.06 | 0.06 |
| Mineral mix⁴ | 0.07 | 0.07 |
| Choline Chloride 60% | 0.02 | 0.02 |
| Quantum Phytase XT 2500 | 0.02 | 0.02 |
| Coban | 0.04 | 0.04 |
| Sand/SolkaFloc⁵ | 2.36 | 2.36 |
| Calculated analysis | | |
| M.E. (KCAL/KG) | 2804 | 2804 |
| Crude protein (%) | 23.07 | 23.07 |
| Calcium (%) | 0.95 | 0.95 |
| Available phosphorus (%) | 0.47 | 0.47 |
| Digestible met and cys (%) | 0.95 | 0.95 |
| Digestible lysine (%) | 1.25 | 1.25 |
| Digestible threonine (%) | 0.81 | 0.81 |

Birds when fed with enzyme treated DDGS gained 3,5% more weight as compared with control DDGS (see FIG. 1 and Table 2). At the same time the feed to gain rate reduced by 2% (see FIG. 2). This shows that the enzyme treated DDGS is a high value feed ingredient which can be included at 10% already in early stage feeding of broilers with improved growth and feed efficiency.

TABLE 2

| DDGS source | End body weight [kg] |
|---|---|
| Control DDGS | 0.422 |
| BluZy DDGS | 0.436 |

### Example 2

### Determination of Metabolizable Energy of Enzyme Treated DDGS

True metabolizable energy (TME) is determined in Single Comb White Leghorn roosters. Roosters are fasted for 24 hours and are then fed with 30 g of test feed ingredient comprising treated or control DDGS. Excreta are collected for 48 hours and analyzed for energy using a Parr Instruments bomb calorimeter. True digestibility (energy or mineral) is determined as the percentage of the difference of the nutrient delivered during the test feeding and the nutrient recovered in the excreta collected over the 48 hour period corrected by the endogenous losses calculated from the fasted birds. Energy determination will be corrected for N.

TABLE 3

| | TMEn |
|---|---|
| | Dry |
| Sample | kCal/kg |
| Production batch A | |
| Control DDGS | 3708 |
| BluZy-D DDGS | 3920 |
| Production batch B | |
| Control DDGS | 3422 |
| BluZy-D DDGS | 3711 |

As shown in table 3, treated DDGS had an increase in TME_{N} content of 6%-8% compared to non enzyme treated DDGS.

1. An animal feed composition suitable for feeding monogastric animals, in particular for poultries like broilers, comprising 5.0 to 15.0, preferably 10.0 weight percent of a distillers dried grains with solubles (DDGS), wherein said DDGS has:
(a) a crude fiber content less than 5.0 weight percent,
(b) a NDF content of less than 30.0 weight percent, and
(c) a ADF content of less than 10 weight percent.

2. The animal feed composition according to claim 1, wherein said DDGS has:
a) a crude fiber content of from 3.0 to 5.0 weight percent,
b) a NDF content of less than 30.0 weight percent, and
c) a ADF content of less than 10 weight percent.

3. The animal feed composition according to claim 1, wherein said DDGS is produced as a by-product in a fermentation process comprising the step of subjecting the fermented mash after the fermentation to an enzyme composition comprising an enzyme or a mixture of enzymes capable of degrading one or more fermented mash components.

4. The animal feed composition according to claim 3, wherein the metabolizable energy (TME) value of said DDGS is at least 5% higher compared to DDGS produced in a fermentation process without subjecting the fermented mash after the fermentation to an enzyme composition.

5. The animal feed composition according to claim 3, wherein the metabolizable energy (TME) value of said DDGS is between 6% to 8% higher compared to DDGS produced in a fermentation process without subjecting the fermented mash after the fermentation to an enzyme composition.

6. The animal feed composition according to claim 1, wherein the animal feed composition is suitable for feeding poultries in the feeding period of 0 to 14 days.

7. The animal feed composition according to claim 3, wherein the enzyme composition comprises an enzyme selected from the group consisting of amylase, alpha-amylase, glucoamylase, cellulase, beta-glucanase, hemicellulase, xylanase, pectinase, mannanase, and protease, or a mixture thereof.

8. The animal feed composition according to claim 3, wherein the enzyme composition comprises a beta-1,3-glucanase, a beta-1,3-glucanase and a 1,6-beta-glucanase, a xylanase, a beta-1,3-glucanase and a xylanase, a beta-1,3-glucanase, a 1,6-beta-glucanase and a xylanase, a pectinase, a protease, a beta-1,3-glucanase, a xylanase and a pectinase, a beta-1,3-glucanase, a xylanase and a protease, a mannanase, or a mannanase and a beta-1,3-glucanase.

9-26. (canceled)

27. A monogastric animal feed comprising at least 10 percent DDGS on a dry weight basis, wherein said DDGS is generated as a by-product in a fermentation process comprising the step of subjecting the fermented mash after the fermentation to an enzyme composition comprising an enzyme or a mixture of enzymes capable of degrading one or more fermented mash components.

28. The monogastric animal feed according to claim 27, wherein the monogastric animal feed is poultry feed.

29. The monogastric animal feed according to claim 28, wherein the poultry feed is broiler feed.

30. The monogastric animal feed according to claim 27, wherein the monogastric animal feed is swine feed.

31. The monogastric animal feed according to claim 27, wherein the enzyme composition comprises a beta-1,3-glucanase and a xylanase.

32. The monogastric animal feed according to claim 27, wherein the enzyme composition comprises a beta-1,3-glucanase, a 1,6-beta-glucanase, and a xylanase.

33. A method of feeding broilers in the feeding period of 0 to 14 days after birth comprising feeding the broilers with an animal feed composition according to claim 1.
